(19) United States
(12) Patent Application Publication
(10) Pub. No.: US 2004/0031459 A1
(43) Pub. Date: Feb. 19, 2004

(54) Two-cycle internal combustion engine

(76) Inventor: William Delaplaine Green, Ocala, FL (US)

Correspondence Address: William Delaplaine Green, 8906 Camden Street P., Alexandria, VA, 22308, US

(21) Appl. No.: 10/637,841

(22) Filed: Aug. 8, 2003

Related U.S. Application Data
(63) Continuation-in-part of application No. 09/923,414, filed on Aug. 8, 2001, now abandoned.

(51) Int. Cl. F02P 15/00

(52) U.S. Cl. 123/159

(57) ABSTRACT

A new two-cycle internal combustion piston engine in which combustion originates within the cylinder head between a positive displacement gear type air compressor and an intake valve sealing the cylinder from the compressor outlet. At approximately TDC fuel is injected into the cylinder head combustion passages initiating combustion and the camshaft opens the intake valve. The opening intake valve allows the burning fuel mixture to flow into the cylinder forcing the piston towards BDC. The compressor is crankshaft driven and continues to force air into the cylinder head combustion passages while the engine runs which causes the fuel to burn more rapidly increasing engine torque. Exhaust valves located in the cylinder head are opened at BDC by the cam as the intake valve closes. The piston forces all the exhaust gases held within the cylinder out the open exhaust ports as it returns to TDC providing this two-cycle engine an exhaust cycle essentially the same as found in a conventional four-cycle internal combustion piston engine.

This is a continuation in part based upon utility patent application Ser. No. 09,923,414 filed Aug. 8, 2001.

### INFORMATION DISCLOSURE STATEMENT

In preparation for the filing of this application, a pre-examination patent ability search was performed. Among the classes and subclasses reviewed were Class 123, subclasses 27R, 65B, 65BA, 68, 198C, 213, 257, 268, 316, 528, 533, 559.1, 561, 565, and 564. Computer searching was also done on the PTO patent database. The search uncovered the following:

| Patent NO. | Inventor | Date of Issue |
|---|---|---|
| 6,135,070 | R. A. Crandall | Oct. 24, 2000 |
| 5,878,703 | K. Sweeney | Mar. 9, 1999 |
| 5,747,163 | E. Green | May 5, 1998 |
| 5,388,561 | H. Cullum, J. Korn | Feb. 14, 1995 |
| 5,375,581 | G. Alander, H. Hofman | Dec. 27, 1994 |
| 5,179,921 | V. Filiuzzi | Jan. 19, 1993 |
| 4,984,540 | K. Morikawa | Jan. 15, 1991 |
| 4,860,699 | J. Rocklein | Aug. 29, 1989 |
| 4,671,218 | C. Weiland | Jun. 9, 1987 |
| 4,539,938 | R. R. Toepel | Sep. 10, 1985 |
| 4,398,509 | E. Offenstadt | Aug. 16, 1983 |
| 2,851,021 | G. W. Covone | Sep. 9, 1958 |
| 2,708,919 | R. D. Wellington | May 24, 1955 |
| 2.686,503 | V. C. Reddy | Aug. 17, 1954 |
| 2,356,379 | D. F. Cans | Aug. 22, 1944 |
| 2,312,661 | D. Messner | Mar. 2, 1943 |
| 2,067,984 | J. Ross | Jan. 19, 1937 |
| 2,062,621 | F. A. Truesdale | Dec. 1, 1936 |
| 1,720,414 | F. Gruebler | Jul. 9, 1929 |
| 1,273,667 | J. A. Poyet | Jul. 23, 1918 |
| 1,220,893 | E. A. Rundlof | Mar. 27, 1917 |

### BACKGROUND OF THE INVENTION

1. Field of Invention

This invention relates to internal combustion engines, specifically two-cycle reciprocating piston engines.

2. Discussion of Prior Art

Designs for two cycle internal combustion engines are disclosed in the art that use positive displacement pumps to charge the cylinder with air prior to ignition. Compressed air is also used to scavenge the cylinder of combustion products during the exhaust cycle of the engine. Often a camshaft operated poppet valve closing off the cylinder from the air passage leading from the air compressor is timed by the camshaft to open and allow the compressed air to enter the cylinder during part of the exhaust cycle to fill the cylinder and push out remaining exhaust gases before the exhaust port closes.

One such design is disclosed in the U.S. Pat. No. 4,671,218 issued to Weiland. In this patent there is disclosed a gear type positive displacement pump used to charge a holding chamber located above the cylinder with compressed air through which a valve stem projects to a valve face that seals the intake port located in the floor of the holding chamber from the cylinder beneath it. A crankshaft driven camshaft actuates the intake valve while the exhaust ports are open, which are located in the cylinder wall just above the face of the piston when it is at top dead center, allowing compressed air from the compressor to fill the cylinder and scavenge the cylinder of remaining exhaust gases.

While this design appears to be simple and straightforward is has the disadvantage of allowing the intake charge to cool the exhaust gases thus reducing the effectiveness of the catalytic converters used in the engine exhaust system to reduce emissions. In order for this type of two-cycle engine to retain the high exhaust temperature of the exhaust gases that occur at the bottom of the power stroke no mixing of the intake charge and the exhaust charge is allowed. Mixing of the intake and exhaust charges of the two-cycle intake combustion engine had always been a design mistake, which until now was unavoidable using current technology. The simple solution to this problem is to move the location of the combustion chamber in the engine from between the intake valve and the piston to between the intake valve and the compressor. In this way the intake valve can close at or before BDC and remain closed until approximately TDC. At BDC exhaust valves located in the engine head can be opened and as the piston returns to TDC it can force the exhaust gases out through the open exhaust ports as is typically done in a conventional four cycle internal combustion engine design.

Achieving a four cycle type exhaust stroke in a two cycle engine design overcomes one of the greatest obstacles to it's commercialization as a possible replacement for the conventional four cycle engine as currently available in passenger automobiles worldwide. By using a crankshaft driven supercharger or compressor to charge the two cycle engine cylinder the greatest fault of conventional two cycle design is eliminated which is the requirement of mixing the oil with the gasoline to lubricate the crankshaft and rod/piston assembly of the engine.

Simply by using a gear type air compressor to charge a combustion chamber located in the engine head between the intake valve and the compressor and originating combustion there the two most important obstacles to the commercialization of the two cycle engine as a viable passenger car engine are eliminated. This is because of all the types of compressor/supercharger types illustrated in the patents searched, whether they be radial, Roots, or turbochargers, only the gear pump type of compressor/supercharger is able to withstand and maintain the high pressures developed during combustion in the combustion chamber of a two cycle internal combustion engine which allows the engine designer to expose the gears of the compressor to the combustion process making it possible to eliminate the above mentioned obstacles to passenger car use of a two cycle internal combustion engine. In addition more oxygen can be pumped into the combustion process by the compressor and that results in faster burning of the fuel charge creating more energy closer to the TDC piston position. This feature of the engine's design is inherently a more efficient use of the fuel burned since more pressure is exerted upon the piston face for a longer time as it moves from TDC to BDC.

In an embodiment using a camshaft operated intake and exhaust valves the camshaft is located above the compressor and the valve ports are located below the compressor. In this design the valve stems pass through valve guides in the housing located between the two gear shafts of the compressor. This allows the design to appear very similar to a conventional overhead cam four cycle engine and appear to function like one as well with the main exception being that a power stroke occurs each revolution of the crankshaft instead of every other revolution of the crankshaft because it is a two cycle engine design instead of a four cycle engine design.

### OBJECTS AND ADVANTAGES

It is therefore an important object of the present invention to describe and illustrate a two-cycle internal combustion piston engine design that has an exhaust cycle like a conventional four-cycle internal combustion piston engine design that uses a crankshaft driven positive displacement gear type compressor to compress gas and fuel into an overhead cam, overhead valve cylinder head where combustion is initiated and eliminate mixing oil with the gasoline as in a conventional two-cycle internal combustion piston engine design in order to create an efficient, powerful, low exhaust emissions two-cycle internal combustion piston engine.

It is a further object of the invention to describe and illustrate a two-cycle internal combustion piston engine that can add oxygen to the combustion process by compressing the fuel mixture between a compressor and either an intake valve or a piston.

This discussion has outlined some of the more important objects of the invention. These objects should be construed as illustrative of the more obvious features and applications of the present invention. Many more important results may be obtained by applying the disclosed invention in different ways and modifying it within the scope of the disclosure. Accordingly, by referring to the detailed description and the various embodiments taken together with the accompanying drawings and claims a more complete understanding of the invention may be ascertained.

### SUMMARY OF THE INVENTION

This invention comprises a two-cycle internal combustion engine. The simplest embodiment having a housing made of two identical parts bolted together for ease of manufacture, strength, ease of assembly or disassembly. The housing has an intake port located in the uppermost wall of the housing for passing air into a gear pump type air compressor. The engine includes the air compressor formed of two partial cylinders enclosing the two gear shafts of the air compressor within the upper part of the engine housing below the intake port. The gear shafts output shafts pass through holes in the outer housing walls for the takeoff of power, and one of them is connected by rotational means to the output shaft of the crankshaft for a transfer of power between them. A passage for holding compressed air connects the outlet side of the air compressor to the top end of the cylinder confining the piston of the engine so the compressor gears and the piston of the engine are simultaneously exposed to the force of combustion. A fuel injection nozzle is located in the intake port for injection of fuel into the port. The piston/rod and crankshaft assemble function in the conventional way and a conventional oil pump is used to pump oil through the engine for lubrication. Cooling passages are formed within the housing and the gear shafts to allowing coolant to flow through them. An exhaust port is located in the cylinder wall above the piston face at BDC for the exhaust of combustion gases.

In any embodiment of this invention conventional sensor means, control means, computer means, electrical means, engine management means, oiling means, bearing means, cooling means, starting and stopping means well known in the art may be employed to produce optimum engine performance and usability.

### BRIEF DESCRIPTION OF THE DRAWINGS

### Submitted with Preliminary Drawings

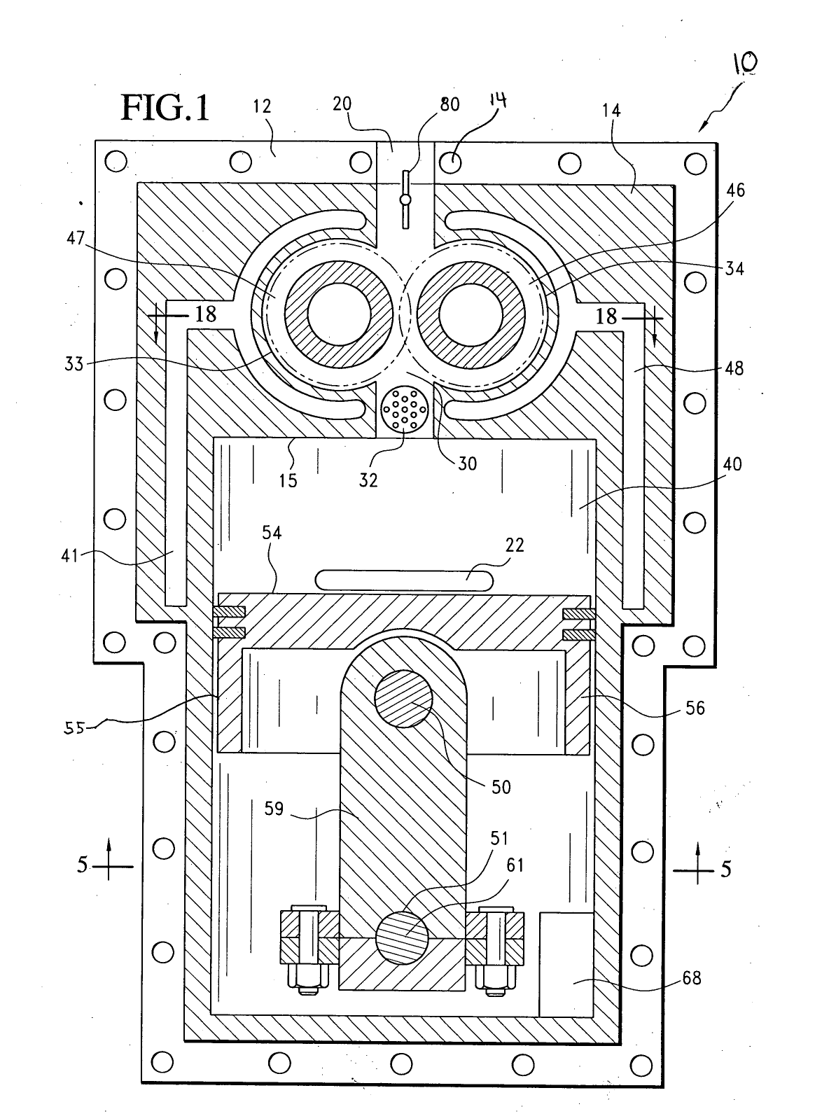

FIG. 1 is a side section view through a two cycle internal combustion engine in accordance with one embodiment of the invention.

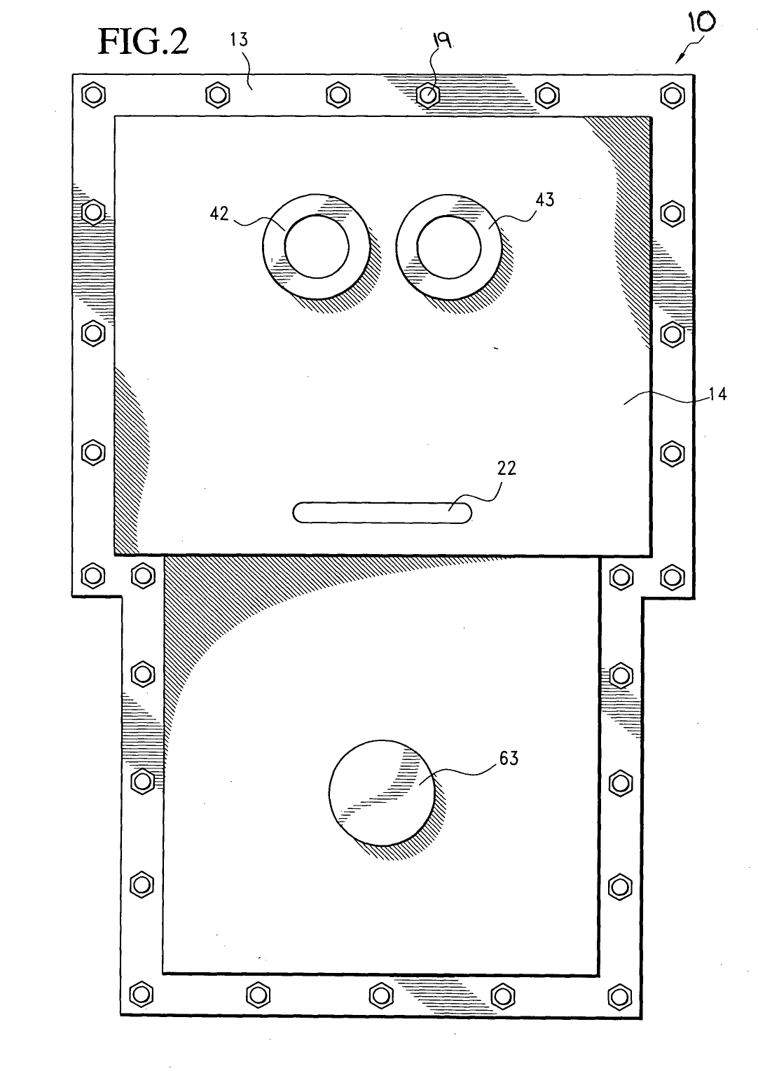

FIG. 2 is a side elevation view of the internal combustion engine shown in FIG. 1.

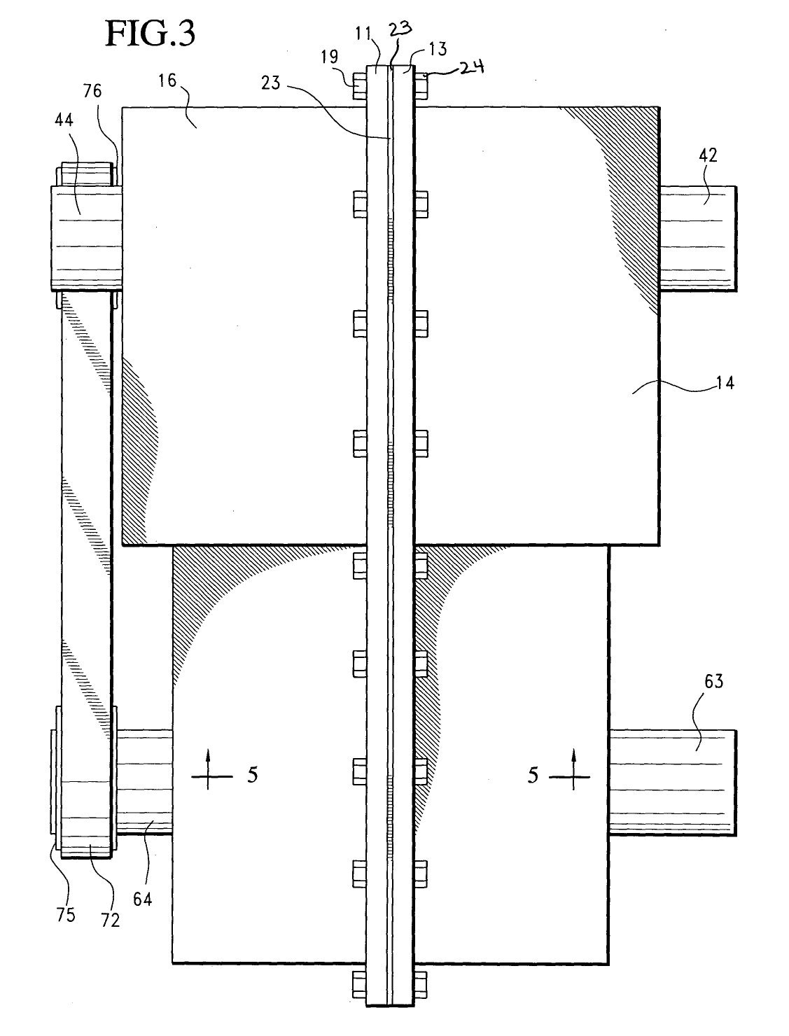

FIG. 3 is a side elevation view of the internal combustion engine shown in FIG. 1.

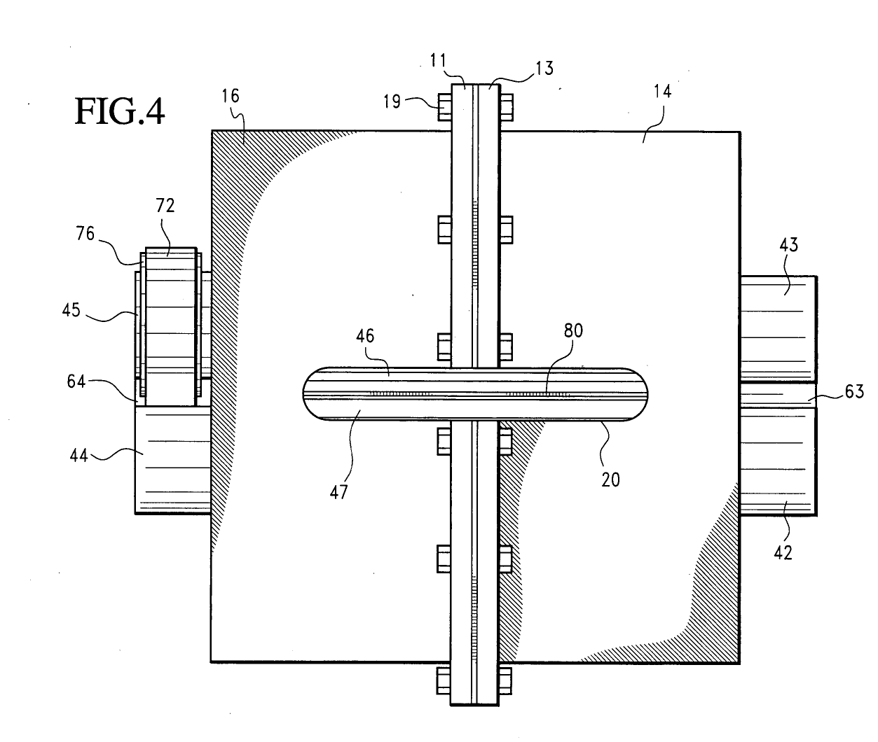

FIG. 4 is a top plan view of the internal combustion engine shown in FIG. 1.

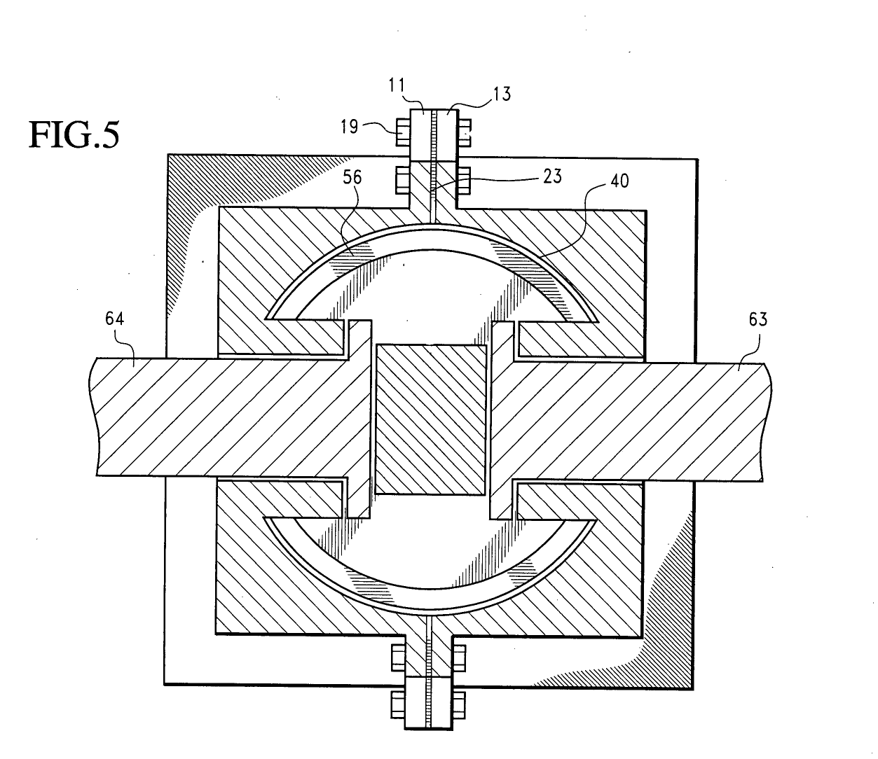

FIG. 5 is a transverse section view taken through a plane indicated by section line 5-5 in FIG. 1.

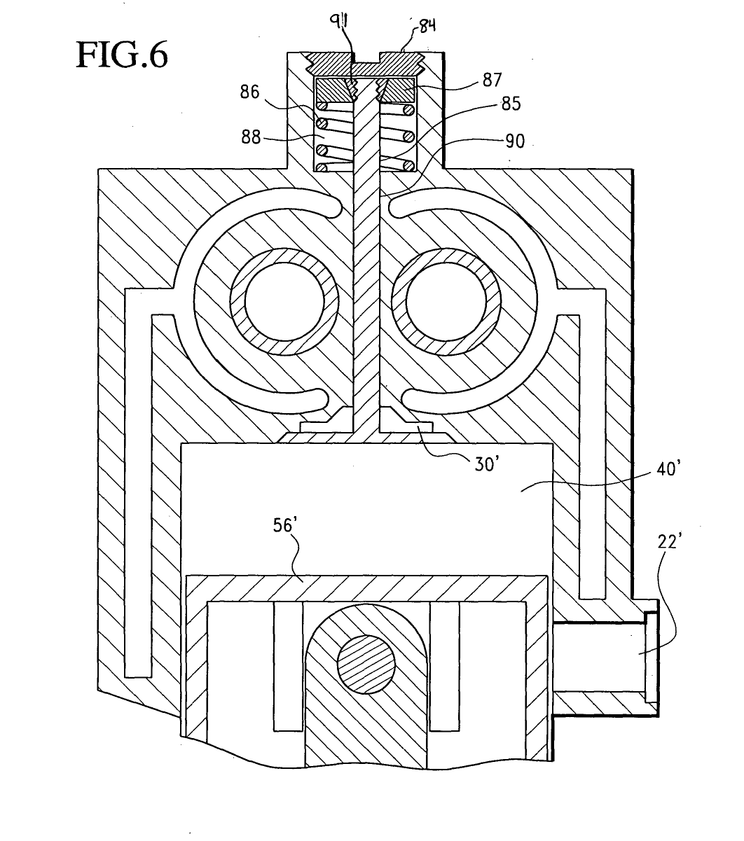

FIG. 6 is a side section view through a two-cycle internal combustion engine in accordance with one embodiment of the engine.

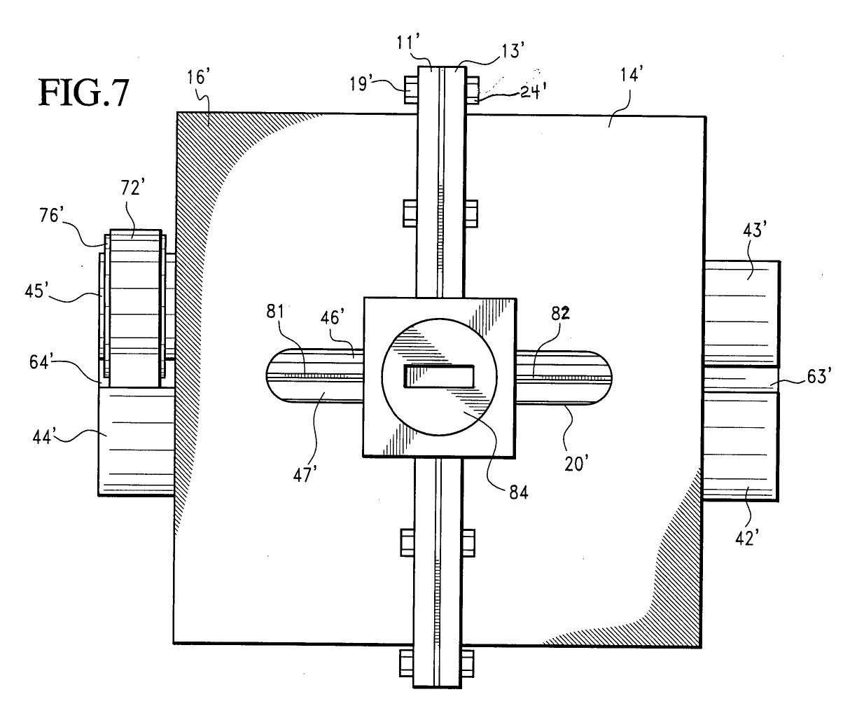

FIG. 7 is a top plan view of the internal combustion engine shown in FIG. 6.

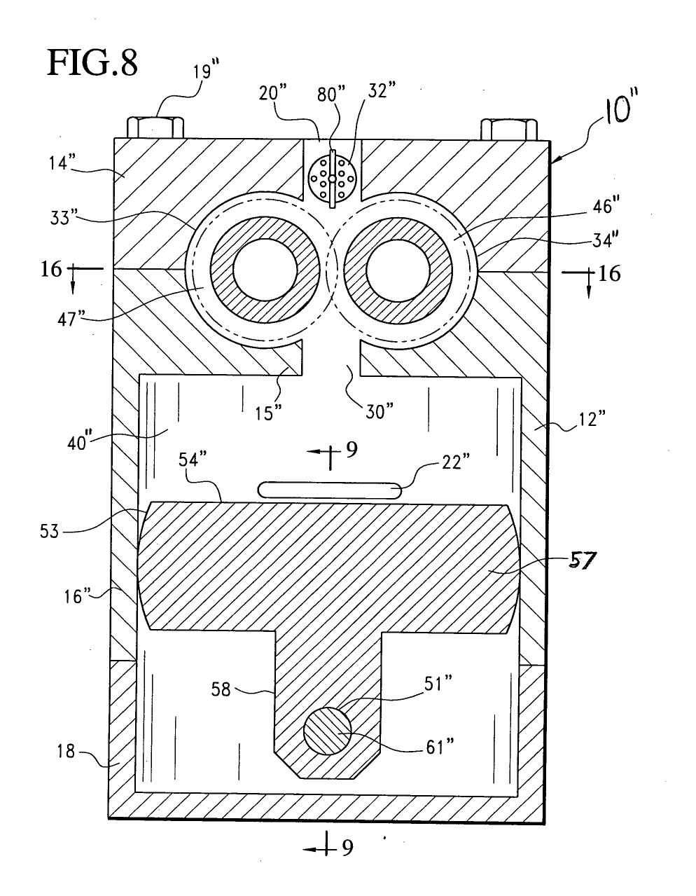

FIG. 8 is a side section view through a two-cycle internal combustion engine in accordance with one embodiment of the engine.

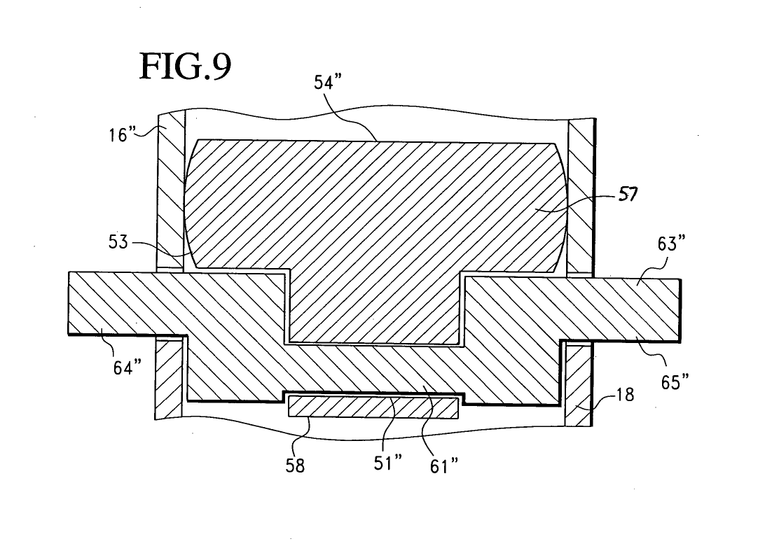

FIG. 9 is a partial side section view of the two cycle internal combustion engine shown in FIG. 8 taken through a plane indicated by section line 9-9.

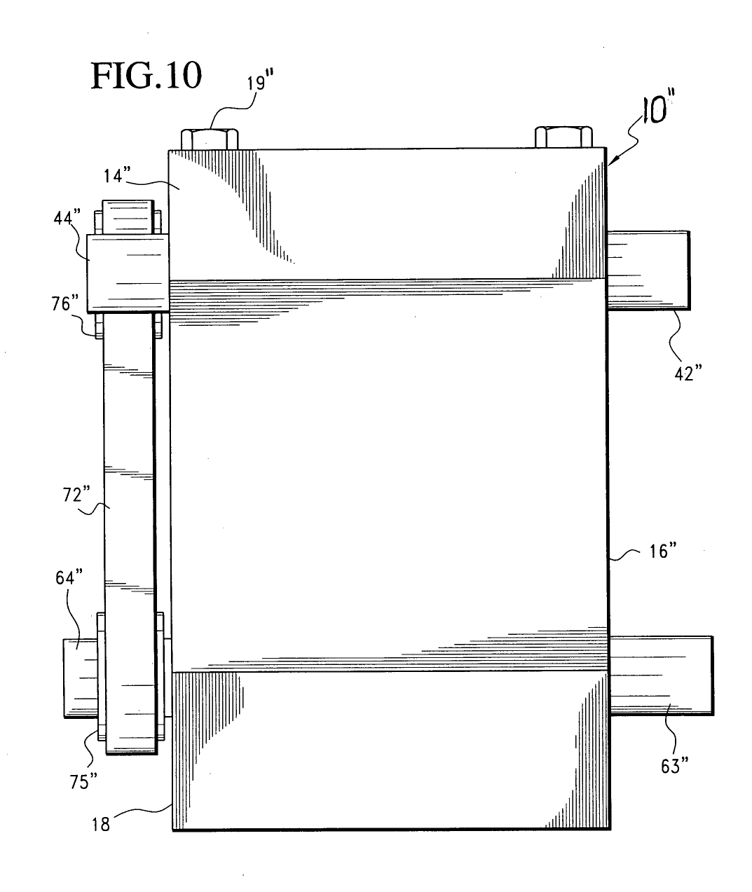

FIG. 10 is a side elevation view of the two-cycle internal combustion engine shown in FIG. 8 in accordance with one embodiment of the engine.

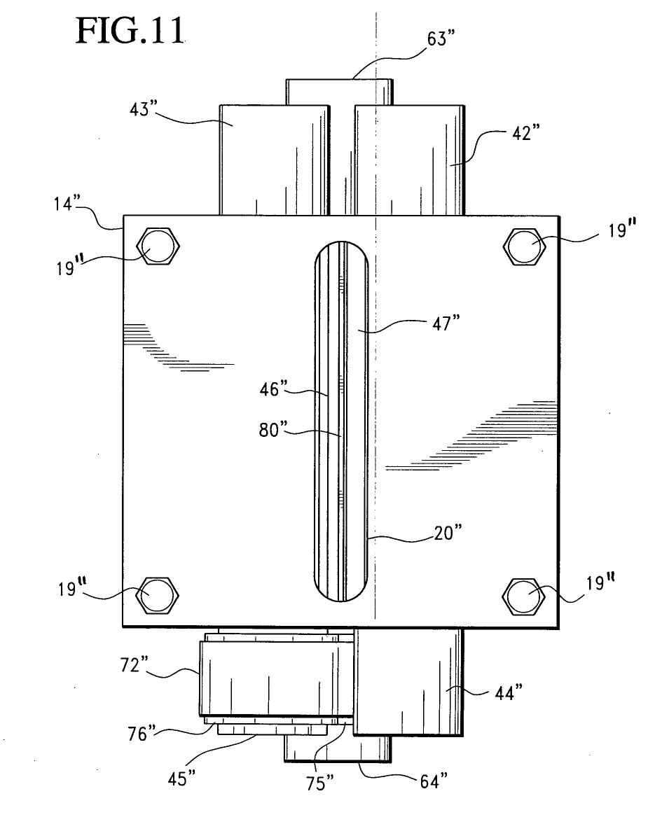

FIG. 11 is a top plan view of the internal combustion engine shown in FIG. 8.

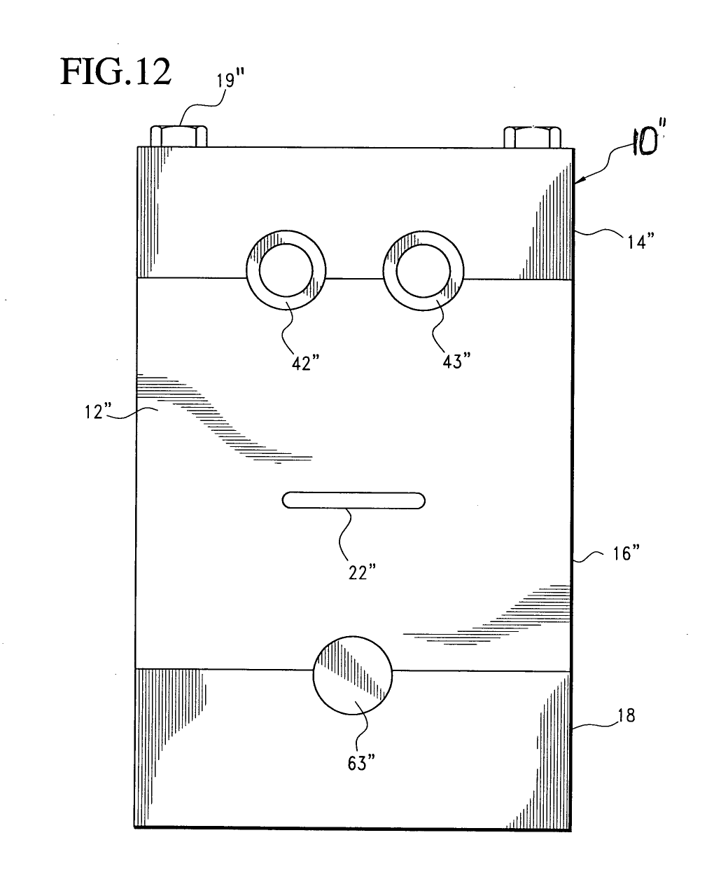

FIG. 12 s a side elevation view of the internal combustion engine shown in FIG. 8.

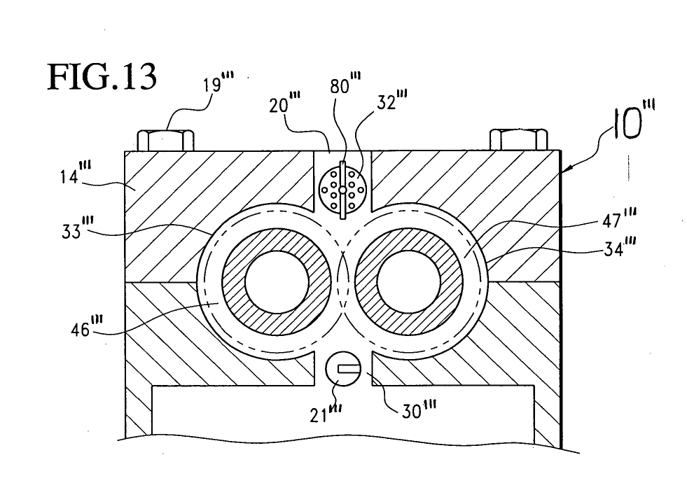

FIG. 13 is a partial side elevation view of the two-cycle internal combustion engine shown in FIG. 8 in accordance with one embodiment of the engine.

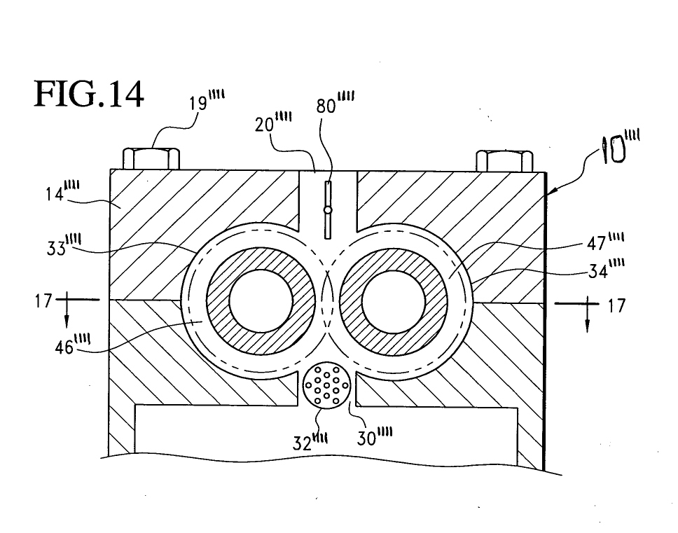

FIG. 14 is a partial side elevation view of the two-cycle internal combustion engine shown in FIG. 8 in accordance with one embodiment of the engine.

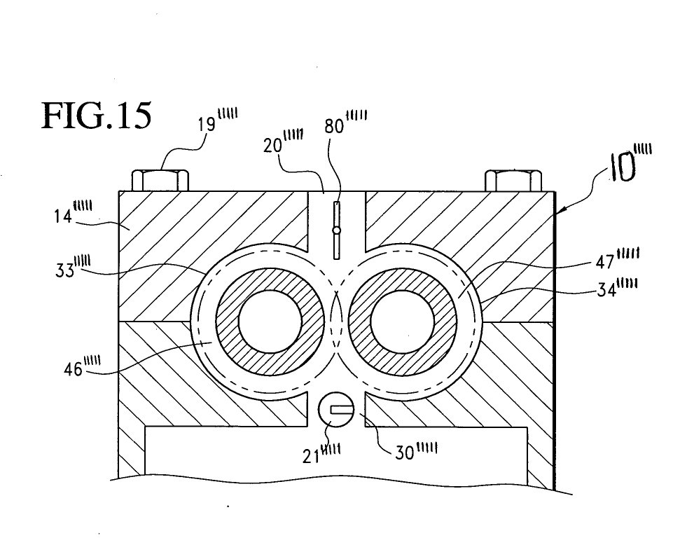

FIG. 15 is a partial side elevation view of the two-cycle internal combustion engine shown in FIG. 8 in accordance with one embodiment of the engine.

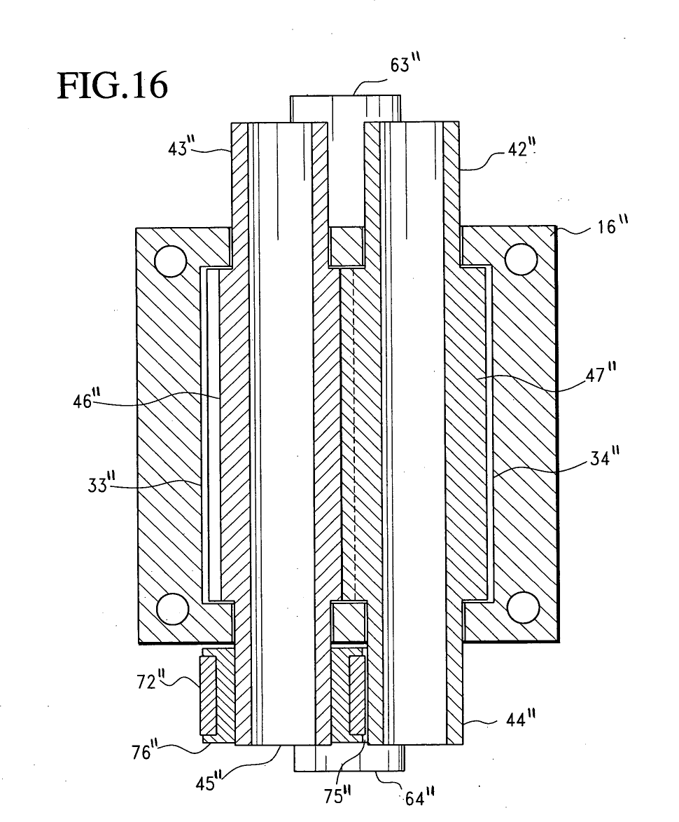

FIG. 16 is a transverse section view taken through a plane indicated by section line 16-16 in FIG. 8.

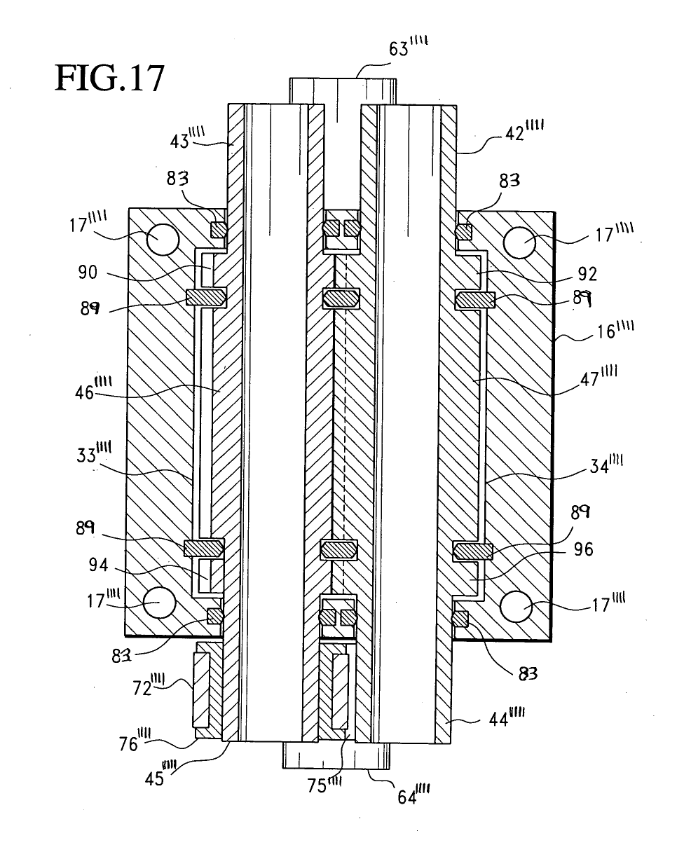

FIG. 17 is a transverse section view taken through a plane indicated by section line 17-17 in FIG. 14.

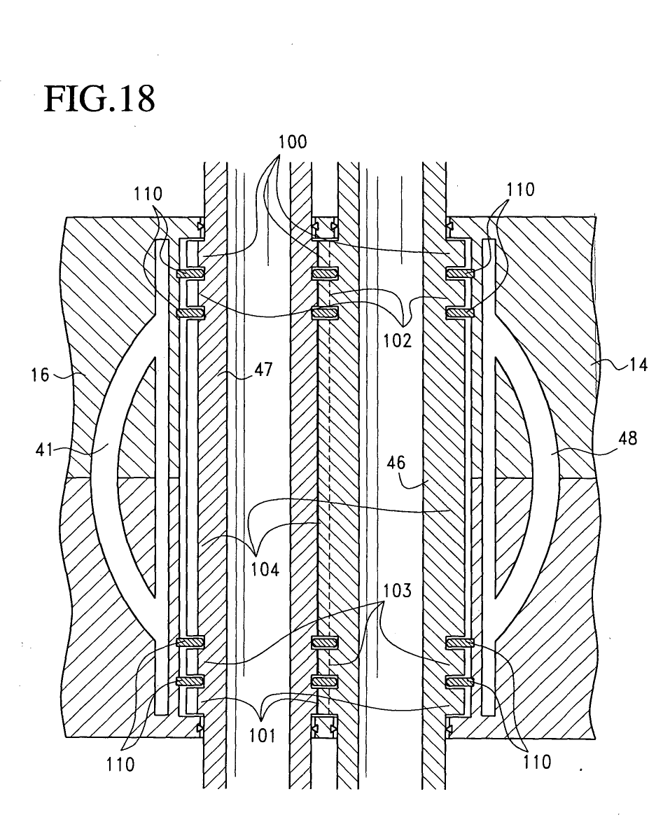

FIG. 18 is a transverse section view taken through a plane indicated by section line 18-18 in FIG. 1.

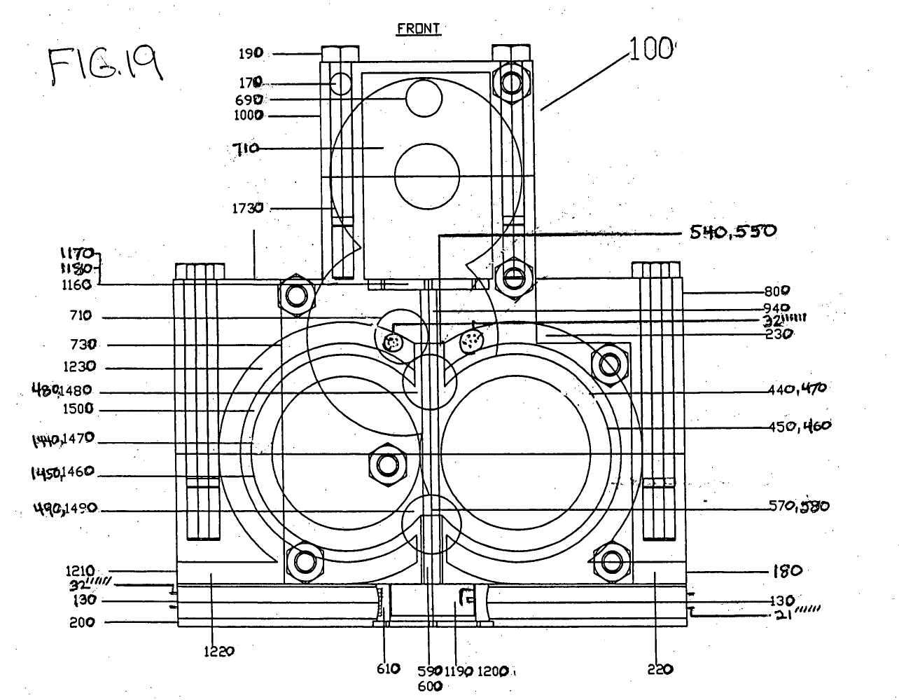

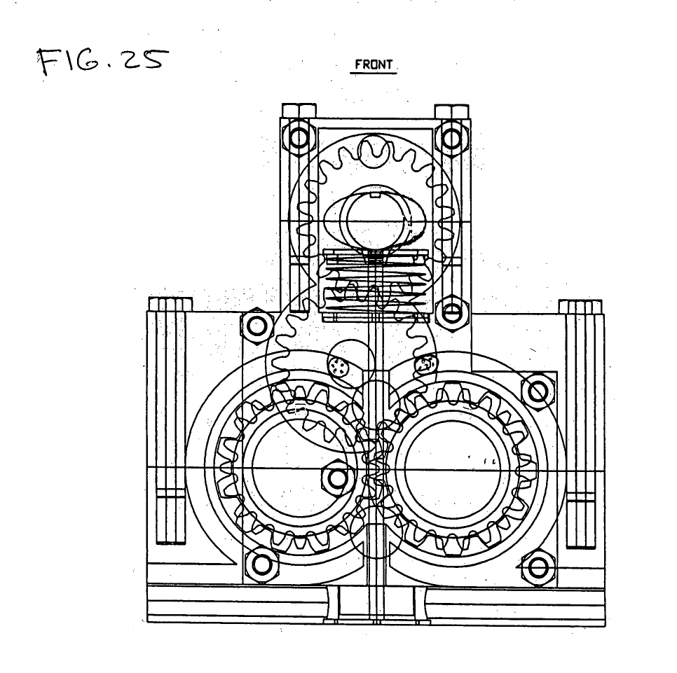

FIG. 19 is a front wire frame view of the housing of the engine head illustrated in FIG. 25 of a two-cycle internal combustion engine.

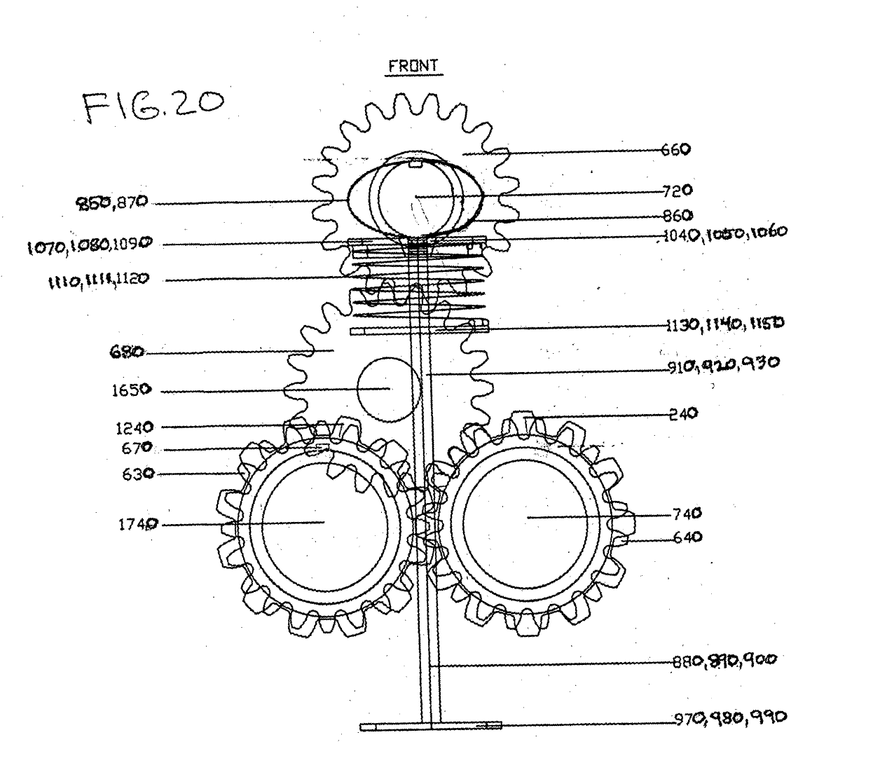

FIG. 20 is a front wire frame view of the moving parts within the engine head illustrated in FIG. 25 of a two-cycle internal combustion engine.

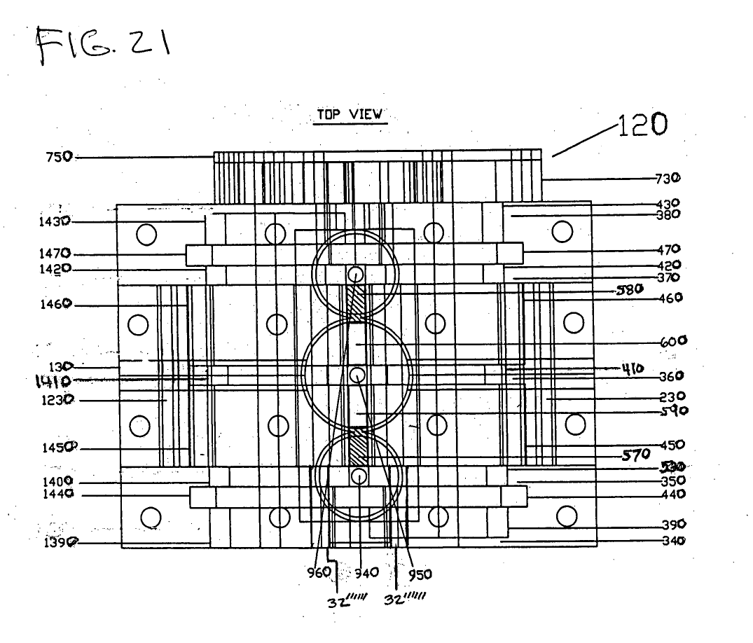

FIG. 21 is a top wire frame view of the housing of the engine head illustrated in FIG. 25 of a two-cycle internal combustion engine.

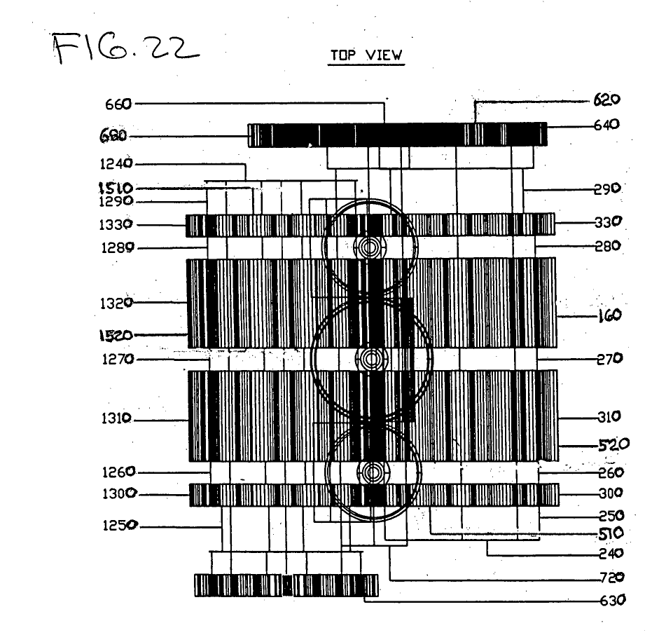

FIG. 22 is a top wire frame view of the moving parts of the engine head illustrated in FIG. 25 of a two-cycle internal combustion engine.

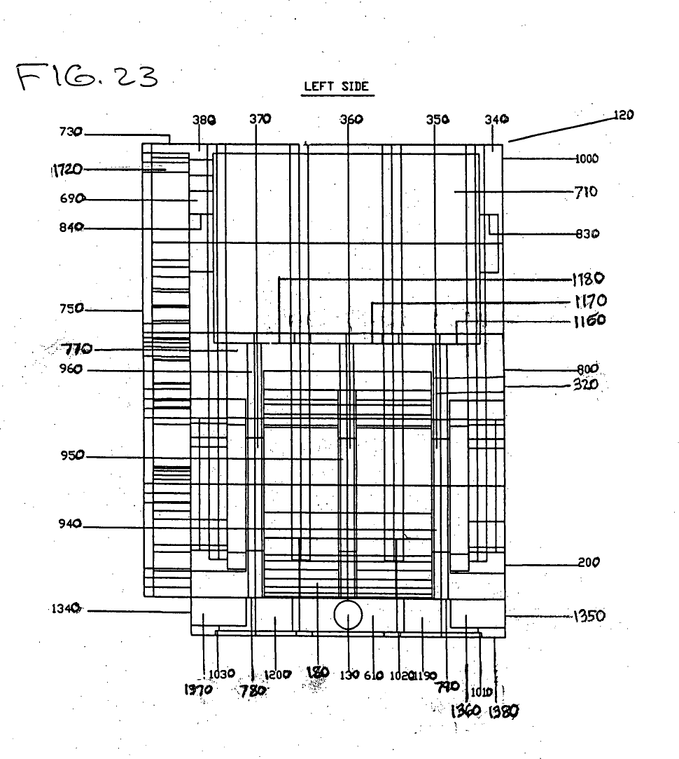

FIG. 23 is a side wire frame view of the housing of the engine head illustrated in FIG. 25 of a two-cycle internal combustion engine.

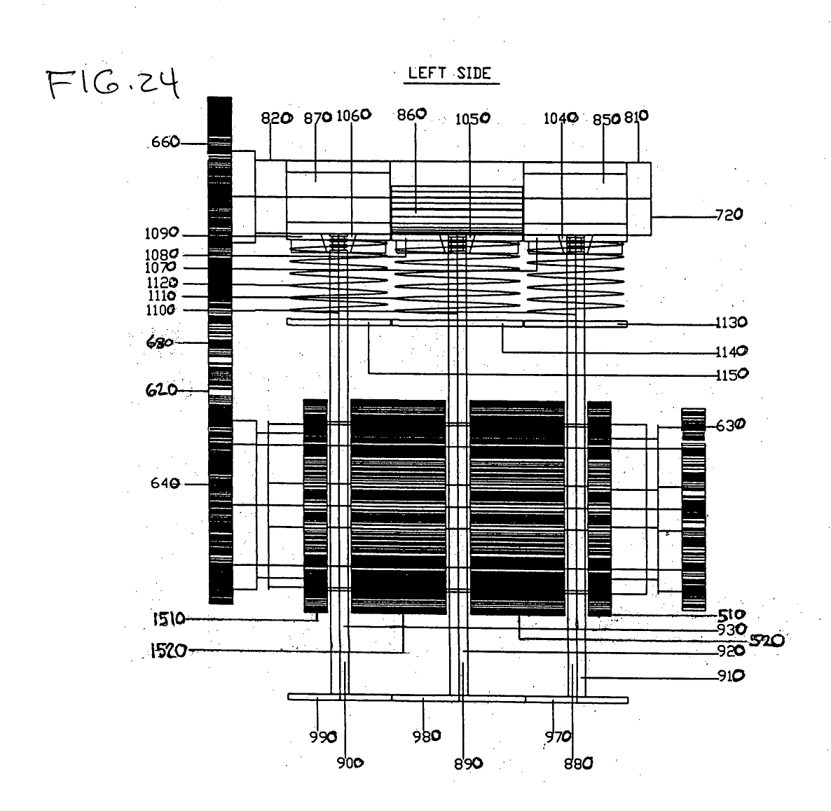

FIG. 24 is a side wire frame view of the moving parts of the engine head illustrated in FIG. 25 of a two-cycle internal combustion engine.

FIG. 25 is a front wire frame view of the head of a two-cycle internal combustion engine according to one embodiment of the invention.

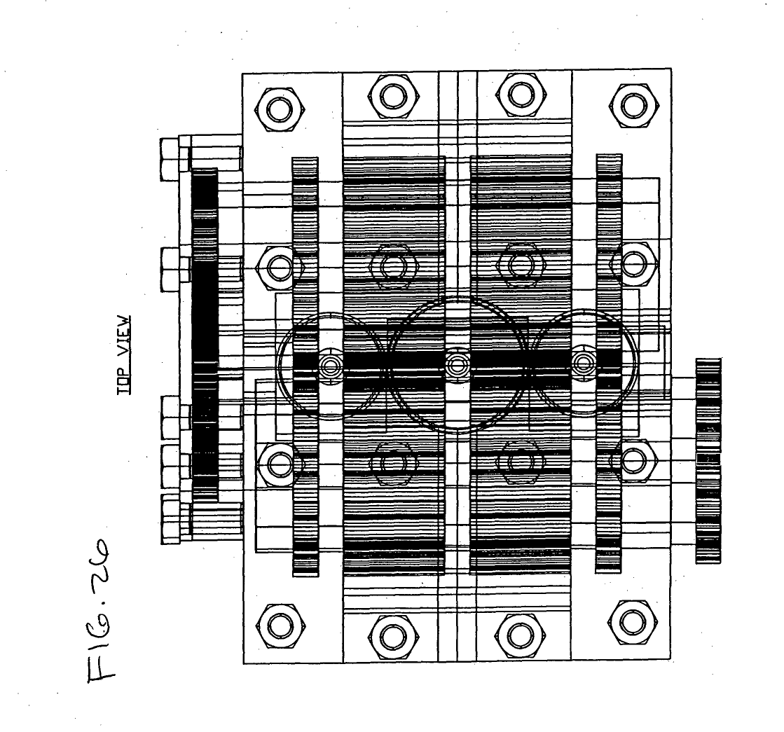

FIG. 26 is a top wire frame view of the engine head illustrated in FIG. 25 of a two-cycle internal combustion engine.

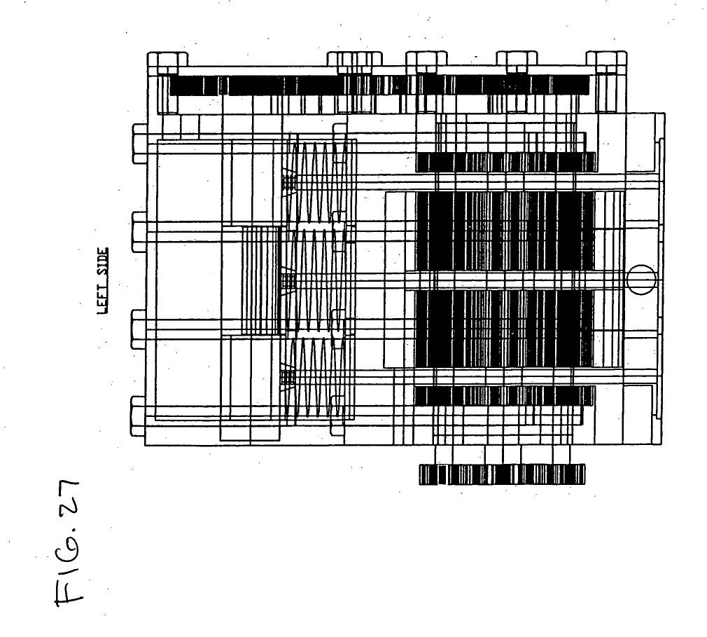

FIG. 27 is a side wire frame view of the engine head illustrated in FIG. 25 of a two-cycle internal combustion engine.

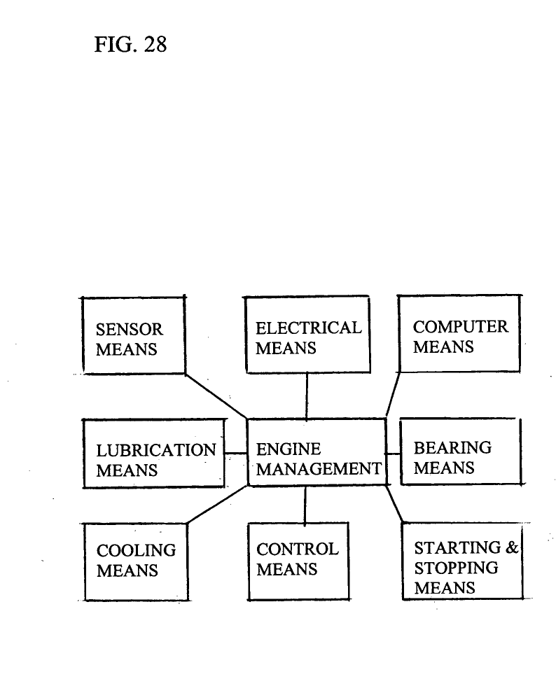

FIG. 28 is the set of conventional means that may be used in design of this engine.

### DESCRIPTION OF THE PREFERRED EMBODIMENT

Referring now to the drawings in detail, FIGS. 1-5 and 18 illustrate a two cycle internal combustion engine constructed in accordance with one embodiment generally referred to by reference number 30. In this embodiment the engine is enclosed by a housing assembly 32, which is formed from two housing sections, 34 and 36. Bolts 39 pass through bolt holes 37 in flanges 31 and 33 surrounding sections 34 and 36 and nuts 44 secure the two housing sections 34 and 36 against gasket 43. As clearly illustrated in FIGS. 1 and 4 an intake port 40 is formed in the top wall of housing sections 34 and 36. A lower end of intake port 40 connects to two partial cylinders 53 and 54 formed in housing section 34 and in housing section 36. They are parallel with crankshaft 85 and contain hollow gear shafts 66 and 67 which are meshed together as can be clearly seen in FIGS. 1, 4, and 18. These gear shafts are divided into sections that form five separate gear pumps used to pump all the working fluids of the engine, coolant, fuel, oil, and oxygen. Gear pumps 120 and 141 are located at the ends of gear shafts 86 and 87 and they pump oil used in the engine. Gear pump 122 can be used to pump fuel used by the fuel injector 52. Gear pump 123 can be used to pump coolant used to cool the engine that passes through cooling passages 61 and 68. Gear pump 124 pumps the air into the engine and functions as a compressor. Passage means are provided to carry fluids to their appropriate locations. Seals 130 are spaced between the gear pumps to prevent mixing of the fluids. Gear shafts 66 and 67 have output shafts 62, 63, 64, and 65 extending through holes formed in the outer vertical walls of housing section 34 and 36 as shown in FIG. 2 and FIG. 4.

Gear shafts 66 and 67 are crankshaft driven, counter rotating in opposite directions drawing intake air through intake port 40 and force the intake air into passage 50 from which it passes into cylinder 60. Fuel injector 52 projects into passage 50 through rear wall of housing section 34 for injecting fuel into passage 50. Partial cylinders 53 and 54 are centrally connected at their lower side to outlet passage 50 traversing the length of partial cylinders 53 and 54 within housing 34 and 36. Passage 50 extends through internal housing wall 35 to cylinder 60 that contains piston 76. As illustrated in FIG. 1 and FIG. 2 formed within cylinder 60 is horizontally and generally elongated exhaust port 42 passing through housing section 34 and having flat upper and lower horizontal sides and curved vertical sides. The lower horizontal side of exhaust port 42 is aligned horizontally with upper horizontal surface face 74 of piston 76 when piston 76 is positioned at bottom dead center position within cylinder 60.

As can be clearly seen in FIG. 1 and FIG. 5 piston 76 has an upper exterior horizontal surface 74 and a circular exterior curved surface 75 tangent with the wall of cylinder 60. Piston pin 70 and piston 76 are rotatably connected to connecting rod 79 rotatably connected to rod journal 81 of crankshaft 85. A can be more clearly seen in FIGS. 2-5, crankshaft output shaft 83 and 84 pass through holes in housing section 34 and 36 for external power transfer from crankshaft 85. Crankshaft output shaft 84 is centrally and fixedly attached to a drive pulley 95. Power transfer belt 92 circumscribes drive pulley 95 and extends around drive pulley 96, which is fixedly attached to output shaft 65 of gear shaft 67. Oil pump 88 pumps oil through passages in the engine to areas requiring lubrication. Coolant flows through water jackets 61 and 68 to remove excess heat from the engine. Throttle plate 100 located in intake port 40 functions as a butterfly valve to control the amount of air the engine receives.

### OPERATION OF THE INVENTION

During operation of the engine the crankshaft output shaft 84 rotates the drive pulley 95 transferring power to drive belt 92 causing drive pulley 96 to rotate. Rotation of drive pulley 96 causes the rotation of gear shaft 67. Teeth of gear shaft 67 move and force the teeth of gear shaft 66 to move forcing rotation of gear shaft 66. Rotation of gear shafts 66 and 67, which are closely confined within partial cylinders 53 and 54 moves air received from intake port 40 along the circumference of partial cylinders 53 and 54 and into passage 50 from which it passes into cylinder 60. As crankshaft 85 rotates crankshaft rod journal 81 pushes rotatable connecting rod 79 which pushes the rotatably connected piston pin 70 and piston 76 towards internal housing wall 35, thereby reducing the volume within cylinder 60 and compressing the air held therein into passage 50. When piston 76 reaches approximately top dead center the fuel injector 52 injects fuel into passage 50 containing the compressed air from the air compressor. High temperature of the compressed air confined within passage 50 ignites the incoming fuel from fuel injector 52 and combustion begins.

Force of combustion transfers energy to the teeth of gear shafts 66 and 67 and to piston 76 simultaneously causing these parts to accelerate. Acceleration of gear shafts 66 and 67 transfers power to their output shafts 62, 63, 64, and 65. Acceleration of piston pin 70 and piston 76 transfers energy to connecting rod 79 which transfers energy to crankshaft 85 thereby transferring power to the crankshaft output shaft 84 which is combined with the power output of gear shaft output shaft 65 through power transfer belt 92 and the associated drive pulleys 95 and 96. As gear shafts 66 and 67 accelerate they pump more air into the engine for combustion causing greater power to be generated. Fuel injector 52 is timed to turn off before piston face 74 of piston 76 passes below exhaust port 42 so the combustion occurring within cylinder 60 can finish before exhaust gases begin to pass out of the engine. Fresh air from the compressor enters cylinder 60 and scavenges it of exhaust gases while the exhaust port 42 is exposed to the volume of cylinder 60 above the face of piston 76 and fills that portion of cylinder 60 with fresh air. As piston 76 moves towards top dead center air between gear shafts 66 and 67 and piston 76 is again compressed into passage 50 making the engine ready for another power stroke.

### DESCRIPTION AND OPERATION OF AN ALTERNATIVE EMBODIMENT

FIGS. 6 and 7 illustrate a different embodiment of the described invention. FIG. 6 shows the embodiment wherein a poppet valve 105 seals passage 50′ from cylinder 60′. Valve stem of valve 105 projects upwards through sections 34′ and 36′ into a compartment 108 containing helical spring 106, retainer 107, and keeper 111 that keep valve 105 tensioned against the lower wall of passage 50′. When combustion of the fuel and air in passage 50′ occurs the force of combustion pushes valve 105 down against the face of piston 76′ forcing it towards bottom dead center. Burning fuel mixture flows into cylinder 60′ through the valve port and continues to force piston 77 towards BDC as the valve closes. At BDC the piston uncovers the exhaust port 42′ and exhaust gases escape through it from the cylinder 60′. Valve 105 closes when fuel injector 52′ (not shown) stops injecting fuel into the engine at which time the fresh air from the compressor flowing into passage 50′ burns out the remaining fuel within passage 50′. Throttle butterfly valves 101 and 102 control the amount of air flowing into the engine. Screw on cap 104 covers the compartment 108. Valve stem of valve 105 passes through valve guide 110.

FIGS. 8-17 illustrate a two cycle internal combustion engine constructed in accordance with one embodiment generally referred to by reference number 30″. In this embodiment the engine is enclosed by a housing assembly 32″ which is formed from three housing sections 34″, 36″, and 38. Bolts 39″ pass through vertical bolt holes 37″ near the corners in sections 34″ ands 36″ and thread into threaded holes 37″ passing through section 38 thereby bolting the three housing sections securely together. As clearly illustrated in FIG. 8 and FIG. 11 an intake port 40″ is formed in the top wall of housing section 34″ and fuel injector 52″ injects fuel into intake port 40″.

Lower end of intake port 40″ connects to two parallel partial cylinders 53″ and 54″ formed in the bottom of housing section 34″ and in the top of housing section 36″. They are parallel with the crankshaft 85″ and contain hollow gear shafts 66″ and 67″ which are meshed together as can be clearly seen in FIGS. 11, 16, and 17. Gear shafts 66″ and 67″ have output shafts 62″, 63″, 64″, and 65″ extending through holes formed in the outer vertical walls of housing sections 34″ and 36″. Gear shafts 66″ and 67″ are crankshaft driven, counter rotating in opposite directions drawing intake air through intake port 40″ and force the intake air into passage 50″ from which it passes into cylinder 60″. Partial cylinders 53″ and 54″ are centrally connected at their lower side to outlet passage 50″ traversing the length of partial cylinders 53″ and 54″ within housing section 36″ and extends through internal wall 35″ to cylinder 60″ that contains reciprocating part 77.

As illustrated in FIG. 8 and FIG. 12 formed within the cylinder 60″ is a horizontal generally elongated exhaust port 42″ passing through housing section 36″ and having flat upper and lower horizontal sides and curved vertical sides. Lower horizontal side of exhaust port 42″ is aligned horizontally with the upper horizontal surface face 74″ of reciprocating part 77 when reciprocating part 77 is positioned at BDC within cylinder 60″. As can be more clearly seen in FIG. 8 and FIG. 9 reciprocating part 77 has an upper exterior horizontal surface face 74″, a circular vertical exterior surface 73 that is tangent with the walls of cylinder 60″ and also has a lower depending section 78. Lower depending section 78 has a transverse bearing hole 71″ formed therein surrounding rod journal 81″ of crankshaft 85″. Upper section of reciprocating part 77 has a sectioned ball shape having a slightly smaller diameter than the cylinder diameter so it can rotate and slide within cylinder 40″ with lower depending section 58 acting as a lever arm that forces the rotation of the upper section having circular vertical sides 53. Reciprocating part 57 and crankshaft 65″ are assembled together so the reciprocating part can be one solid part. When crankshaft 65″ rotates reciprocating part 57 rotates and the exterior circular surface 53 rotates as it slides up and down the wall of cylinder 40″ allowing constant contact with the wall of cylinder 40″.

As can be seen clearly in FIG. 9, FIG. 10, and FIG. 12 crankshaft output shafts 83″ and 84″ pass through holes in housing section 36″ and 38″ for external power transfer from he crankshaft 85″. Crankshaft output shaft 84″ is centrally and fixedly attached to a drive pulley 95″. Power transfer belt 92″ circumscribes drive pulley 95″ and extends around drive pulley 96″ which is centrally and fixedly attached to the output shaft 65″ of the gear shaft 67″.

### OPERATION OF THE INVENTION

During operation of the engine the crankshaft output shaft 84″ rotates drive pulley 95″ transferring power to drive belt 92″ causing drive pulley 96″ to rotate. Rotation of drive pulley 96″ causes the rotation of gear shaft 67″. Teeth of gear shaft 67″ move and force the teeth of gear shaft 66″ to move forcing rotation of gear shaft 66″. Rotation of gear shafts 66″ and 67″, which are closely confined within parallel partial cylinders 53″ and 54″ moves air into passage 50″ from which it passes into cylinder 60″. As crankshaft 85″ rotates crankshaft rod journal 81″ pushes rotatably connected reciprocating part 77 towards internal housing wall 35″, thereby reducing the volume within cylinder 60″ and compressing the air held therein into passage 50″. When reciprocating part 97 reaches approximately top dead center the fuel injector 52″ injects fuel into the incoming air stream within intake port 40″ and the fuel flows with the air into the air compressor. Positive displacement air compressor discharges the fuel and air mixture received from intake port 40″ into passage 50″ containing the compressed air from the compressor. High temperature of the compressed air confined within passage 50″ ignites the incoming fuel mixture from the compressor and combustion begins.

Force of combustion transfers energy to the teeth of gear shafts 66″ and 67″ and to reciprocating part 77 simultaneously causing these parts to accelerate. Acceleration of the gear shafts 66″ and 67″ transfers power to their output shafts 62″, 63″, 64″, and 65″. Acceleration of reciprocating part 77 transfers energy to crankshaft 85″ thereby transferring power to the crankshaft output shaft 84″ which is combined with the power output of gear shaft output shaft 65″ through power transfer belt 92″ and associated drive pulleys 95″ and 96″. As gear shafts 66″ and 67″ accelerate they pump more air into the engine for combustion causing greater power to be generated. Fuel injector 52″ is timed to turn off before face 74″ of reciprocating part 77 passes below exhaust port 42″ so the combustion occurring within cylinder 60″ can finish before exhaust gases begin to pass out of the engine. Fresh air from the compressor enters cylinder 60″ and scavenges it of exhaust gases while exhaust port 42″ is exposed to the volume of cylinder 60″ above the face of reciprocating part 77 and fills that portion of cylinder 60″ with fresh air. As reciprocating part 77 moves towards top dead center air between gear shafts 66″ and 67″ and reciprocating part 77 is again compressed into passage 50″ making the engine ready for another power stroke.

### DESCRIPTION AND OPERATION OF ALTERNATIVE EMBODIMENTS

FIGS. 13, 14, and 15 illustrate different embodiments of the described invention. FIG. 13 shows an embodiment wherein the fuel is injected into intake port 30′″ and ignition means 41′″ is placed in the wall of passage 50′″ for igniting the fuel mixture in passage 50′″. FIG. 14 shows the embodiment wherein fuel is injected into passage 50″″ instead of into port 40″″ by fuel injector 52″″ which is located in the rear wall of passage 50″″. In this embodiment is illustrated in FIG. 17, taken through section lines 17 in FIG. 14, two sets of gears to each side of the compressor gears positioned in partial cylinders 53″″ and 54″″. These two gear sets are comprised of gears 110, 112, 114, and 116 which are submersed in oil to reduce wear and serve to function as a means to control the rate of wear of the main compressor gears. Said gears can be used to pump cooling oil through the hollow gear shafts, through the engine to provide lubricating oil to moving parts requiring lubrication and through an oil cooler. Oil control rings 103 and 109 block oil from escaping from partial cylinders 53″″ and 54″″ confining gears 110, 112, 114, and 116.

Description and Operation of Another Alternative Embodiment

Another embodiment is illustrated in FIGS. 19-27. These drawings illustrate the two cycle internal combustion engine's cylinder head and cylinder heads internal parts constructed in accordance with one embodiment of the invention generally referred to by reference number 120. In this embodiment the engine's cylinder head is enclosed by a housing assembly 140 which is formed from three head sections, 220, 820, and 1020 horizontally divided. Bolts 230 pass through holes 190 located in the top exterior surfaces of head sections 820 and 1020 and thread into threaded holes 190 in head section 220 and head section 820 to secure the housing sections together. Horizontal rectangular intake ports 200 and 1230 are formed in the lower part of head section 200 and centrally positioned above a circular spark plug hole 150 centrally located between the opposite sides of lower head section 220 of housing assembly 140 and project through lower head section from the illustrated side to the opposite side. Fuel injector 52″″″ and spark ignition means 41″″″ are located within hole 150 to inject fuel and ignite it at the proper times. Intake port 200 connects to horizontal intake passage 240 and intake passage 1230 connects to horizontal intake passage 1240 on the opposite side of lower head section 220. Intake passage 240 connects to partially circular intake air passage 250 and horizontal intake passage 1240 connects to partially circular intake passage 1250. Intake air passage 250 is radially positioned around partial cylinder 520 and aligned with the axis of partial cylinder 520. Intake air passage 1250 is radially positioned around partial cylinder 1520 and axially aligned with the axis of partial cylinder 520. Gear shaft 260 having center hole 760 is axially aligned with the axis of partial cylinder 520 and the wall of the partial cylinder 520 is very closely spaced from the outer diameters of the gears of gear shaft 260. Gear shaft 1260 having center hole 1760 is axially aligned with the axis of partial cylinder 1520 and the wall of partial cylinder 1520 is very closely spaced from the outer diameter of the gears of gear shaft 1260. Intake air passing through air passages 250 and 1250 transfers heat received from the cylinder head walls surrounding the air passages 250 and 1250 thereby cooling the cylinder head.

As illustrated in FIGS. 21, 22, and 24 gear shafts 260 and 1260 are divided into four gear sections on each shaft by five bearing sections 270, 280, 290, 300, and 310 on gear shaft 260 and five bearing sections 1270, 1280, 1290, 1300, and 1310 on gear shaft 1260. Two positive displacement oil pump gears 320 and 350 are located near the ends of gear shaft 260. Two positive displacement oil pump gears 1320 and 1350 are located near the ends of gear shafts 1260. Two positive displacement fuel feed gears 330 and 180 are located between oil pump gears 320 and 350 on gear shaft 260. Two positive displacement fuel feed gears 1330 and 1340 are located between oil pump gears 1320 and 1350 on gear shaft 1260.

Positive displacement oil pumps 530 and 1530 are located near the ends of gear shafts 280 and 1260. Positive displacement fuel feed gear pumps 540 and 1540 are located between oil pumps 530 and 1530 on gear shafts 260 and 1260. Positive displacement pumps 530, 540, 1530, and 1540 are formed by meshing together the eight gears located on gear shafts 260 and 1260. Housing bearing holes 410 and 1410, 550 and 1420, 430 and 1430, 440 and 1440, 450 and 1450 pass horizontally through walls 360, 370, 380, 390, and 400 respectively of middle head section 820 and lower head section 220 to provide bearing support for gear shaft bearing surfaces 270, 280, 290, 300, and 310 of gear shaft 260 and bearing surfaces 1270, 1280, 1290, 1300, and 1310 of gear shaft 1260.

As illustrated in FIGS. 19, 21 and 22 horizontal partial cylinders 460 and 1460 formed in middle head section 820 and lower head section 220 between walls 360 and 370 surround positive displacement oil pump 530. Horizontal oil inlet hole 500 passing through wall 360 provides oil access to oil pump 530. Horizontal oil outlet hole 500 passing through wall 360 provides oil access to drive gear 650 fixedly attached to the end of gear shaft 1260 by key 690. Gear shaft drive gear 650 is rotatably connected to crankshaft 85″″″ of the engine by a chain (not shown) that drives gear 830. Upon crankshaft rotation drive gear 830 rotates imparting rotation to attached gear shaft 1260 that drives meshed gear shaft 260.

As illustrated in FIGS. 19, 20, 21, and 22 horizontal partial cylinders 470 and 1470 formed between wall 370 and wall 380 surround positive displacement fuel feed gear pump 540. Partial cylinders 470 and 1470 connect to air connection passage 570 formed between partial cylinders 470 and 1470 at their upper tangency. Upper sides of passage 570 connect to the upper ends of partial circular air passages 250 and 1250. Intake air passes from air passages 250 and 1250 through passage 570 to positive displacement fuel feed gear pump 540 that pumps air received from air connection passage 570 into horizontal combustion passage 590 located between vertical internal wall 370 and horizontal combustion passage 610. Air flows from passage 590 into vertical combustion passage 610 passing downward and then into cylindrical combustion passage 610 located between the horizontal plane of the bottom of valve guide 950 and the top of valve face 980. Combustion passage 610 surrounds and is axially aligned with the axis of valve stem 940 of valve 910 and has an outer diameter the same as the inner diameter of valve seat 1040.

As illustrated in FIGS. 19, 20, 21, and 22 horizontal partial cylinders 480 and 1480 formed between wall 380 and wall 390 surround positive displacement fuel feed gear pump 1540. Partial cylinders 480 and 1480 connect to air connection passage 580 formed between partial cylinders 480 and 1480 at their upper tangency. Upper sides of passage 580 connects to the upper ends of partial circular air passages 250 and 1250. Intake air passes from air passage 250 and 1250 through air connection passage 580 to positive displacement fuel feed gear pump 1540 that pumps air received from air connection passage 580 into horizontal combustion passage 600 located between vertical internal wall 440 and vertical combustion passage 620. Air flows from passage 600 into vertical combustion passage 620 passing downward and then into cylindrical combustion passage 630 located between the horizontal plane of bottom of valve guide 970 and the top of valve face 1000.

As illustrated in FIGS. 19, 21 and 22 horizontal partial cylinders 490 and 1490 formed in middle head section 820 and lower head section 220 between wall 390 and wall 400 surround positive displacement oil pump 1530. Horizontal oil inlet hole 1500 passing through wall 400 provides oil access to oil pump 1530. Horizontal oil outlet hole 1510 passing through wall 400 provides oil access to drive gear train 640. Upon rotation of gear shaft 260 drive gear 660 rotates and drives idler gear 700 rotating on journal 730 and meshed with drive gear 660. Idler gear 700 is meshed with camshaft drive gear 680 with central hole 185 and imparts rotation to gear 680 causing camshaft 740 to rotate upon rotation of gear shaft 260. Drive gear train 640 is comprised of gear 660, idler gear 700, and cam drive gear 680 contained inside gear train housing compartment 1750. Gear train housing compartment 1750 enclosing gear train 640 is formed in housing extension 750 of the lower, middle and upper head sections 220, 820, and 1020 and is covered by flat plate gear train housing extension cover 770 having bolt holes 190 through which bolts 210 thread into bolt holes 190 formed in gear train housing extension 750. Oil hole 710 located in the side of gear train housing compartment 1750 passes through wall 400 and provides oil to camshaft compartment 730.

As illustrated in FIGS. 20, 21, 23, and 24 camshaft 740 end bearing surface 830 is supported by blind bearing hole 850 formed in wall 360. Camshaft 740 end bearing surface 840 is supported by bearing hole 860 passing through wall 400 of upper head section 1020 and the middle head section 820 that join at the horizontal centerline of the camshaft 740. Camshaft 740 has three lobes 870, 880, and 890, which actuate valves 900, 910, 920 respectively. Valves 900, 910, and 920 are comprised of valve stems 930, 940, and 950 respectively which extend through valve guides 960, 970, and 980 respectively formed in lower and middle head sections 220 and 820. Guides 960, 970, and 980 pass through the center portions of internal walls 370, 380, and 390 formed in middle head section 820 and lower head section 220. Guides 960, 970, and 980 are located between head bearing surfaces 550 and 1420, 430 and 1430, 440 and 1440 respectively, allowing valve stems to pass between the bearing surfaces 280 and 1280, 290 and 1290, and 300 and 1300 respectively, of gear shafts 260 and 1260 respectively and extend into valve faces 990, 1000, and 1010 respectively. Valve faces 990, 1000, and 1010 upper outer surfaces are tangent with valve seats 1030, 1040, and 1050 respectively, formed in bottom horizontal wall 1400 of lower head section 220. Valve stems 930, 940, and 950 are connected at their upper ends to split keepers 1060, 1070, and 1080 respectively, which have conical shaped outer surfaces which align with the inner conical holes centrally formed through valve retainers 1090, 1100, and 1110 respectively. Retainers 1090, 1100, and 1110 cover valve springs 1120, 1130, 1140 respectively sitting on valve spring washers 1150, 1160, and 1170 respectively, located on the bottom of valve spring seat holes 1180, 1190, and 1200 respectively, formed in upper interior horizontal wall 790 of middle head section 820. Respective valve keepers, retainers, springs, are axially aligned with each valve stem axis. Respective valve washers and seat holes are axially aligned with each valve guide axis. Springs 1120, 1130, and 1140 are kept under tension by compressing springs 1120, 1130, and 1140 between the upper horizontal surface of washers 1150, 1160, and 1170 and the lower horizontal surface of retainers 1090, 1100, and 1110. Retainers 1090, 1100, and 1110 which are held in position by keepers 1060, 1070, and 1080 have inner circular grooves that are aligned with exterior circular grooves formed near the top ends in stems 930, 940, and 950. Valve faces 970 and 990 cover exhaust passages 1210 and 1220 and valve face 1000 covers cylindrical combustion passage 630. Exhaust passages 1210 and 1220 are circular and project upward from valve seats 1030 and 1050 respectfully, to internal exhaust passage horizontal walls 800 and 810 respectfully, which form the upper walls of internal horizontal rectangular exhaust passages 1380 and 1390 respectfully, that extend through lower head section 220 to exhaust ports 1370 and 1360 respectfully, formed in the opposing external walls of lower head section 220.

Operation of the Invention

Upon starting the engine by rotating the crankshaft gear train 660 causes rotation of camshaft 760 which forces cam lobes 890, 900, and 910 against stems, 950, 960, and 970. Lobes 890, 900, and 910 are radially positioned around the axis of camshaft 760 and center lobe 9000 is oriented to cause middle valve 930 to begin to open approximately upon ignition of the fuel and air mixture in the combustion passages 610, 620, 630, 640, and 650 which is timed to occur approximately when piston 96″″″ reaches top dead center position. Passages 610, 620, 630, 640, and 650 are filled with compressed gas as crankshaft 105″″″ rotates prior to ignition because the crankshaft 105″″″ is rotatably connected by a chain (not shown) to compressor drive shaft drive gear 670 causing rotation of gear shafts 280 and 1280 for each rotation of crankshaft 105″″″. This drive means can be configured to cause greater or less rotation of the air compressor gear shafts (one rotation of gear shafts 260 and 1260 is illustrated per one rotation of the camshaft) for each rotation of camshaft 740 to affect the distribution of heat absorbed by the compressor gear shafts, affect compression of the fuel mixture or cause supercharging during engine operation. Rotation of gear shafts 260 and 1260 causes operation of the four gear pumps 530, 1530, 540, 1540 formed by the meshed gears on gear shafts 260 and 1260. Operation of the two positive displacement gear pumps 540 and 1540 force gas into passages 590, 600, 610, 620, and 630 within cylinder head 120 where compression of the gas occurs. Approximate maximum compression of the gas trapped inside passages 590, 600, 610, 620, and 630 is attained as piston 76″″″ reaches top dead center. Fuel injector 52″″″ are shown placed in passages 250 and 1250 upstream of positive displacement gear pumps 540 and 1540 to inject fuel into passages 250 and 1250 and placed inside of hole 150 to inject fuel directly into combustion passage 630 so fuel can be injected into cylinder head 120 at the desired degree of crankshaft rotation to properly supply fuel to the engine. Spark ignition means such as a spark plug 41″″″ is positioned in hole 150 on the opposite side of combustion passage 630 from the side of combustion passage 630 the fuel injector 52″″″ is located within hole 150 to force ignition of the fuel mixture compressed within combustion passage 630 at the desired moment.

Upon ignition of the fuel mixture combustion occurs within combustion passages 590, 600, 610, 620, and 630 and the burning fuel produces high pressure within the combustion passages 590, 600, 610, 620, and 630 exerting pressure upon the top of valve face 1000 of intake valve 910. The position of intake valve 910 is controlled by the mutual actions of valve spring 1130 and camshaft lobe 870. As intake valve 910 is forced by camshaft 740 downward it moves off valve seat 1040 opening the valve port in the bottom of combustion passage 630 allowing the burning expanding combustion gases to flow into cylinder 60″″″ equalizing the pressures within the cylinder 60″″″ and passages 590, 600, 610, 620, and 630 to force piston 76″″″ downwards towards BDC. As the piston and rod assembly moves downward within cylinder 60″″ under the force of combustion it drives crankshaft 85″″″ which forces the compressor to accelerate because the compressor is driven by rotatable drive means connecting crankshaft 85″″″ and the compressor gear shaft together. Compressor forces more air into passages 590, 600, 610, 620, and 630 as combustion proceeds causing a faster rate of burning to occur. More fuel can be injected into the engine to feed the combustion process until desired to produce maximum power, efficiency, or low emissions. Valve lifts and durations can be tailored to allow the desired amount of air into the cylinder during the power stroke of the engine to produce the desired result.

When piston 76″″″ has reached bottom dead center (BDC) position cam lobes 870 and 890 begin to actuate valves 900 and 920 thereby opening exhaust passages 1210 and 1220 allowing the burned fuel trapped within cylinder 60″″″ to escape through exhaust passages 1210 and 1220 into horizontal rectangular exhaust passages 1380 and 1390 and released out of the engine through exhaust ports 1360 and 1370 as piston 76″″″ returns to the top dead center (TDC) position. Cam lobes 870 and 890 are oriented to close exhaust valves 900 and 920 by the time piston 76″″″ has reached the top dead center position to prevent gas from escaping from cylinder 60″″″ through these exhaust passages during the power stroke of the piston which occurs again as the piston passes the top dead center position.

### CONCLUSIONS, RAMIFICATIONS, AND SCOPE OF THE INVENTION

While the preferred embodiments of the invention have been described and illustrated, it is to be understood that the disclosure is for the purpose of illustration and that various changes and modifications can be made without departing from the scope of the invention as set forth in the appended claims. For example this two-cycle internal engine design can be built as an inline multi cylinder engine, air-cooled radial designs using planetary gear sets planets gears connected to individual crankshafts engine designs, v type engine designs as well as opposed cylinder (flat) engine designs and even w type engine designs. It also lends itself to single cycle engine designs in which ignition occurs at both ends of the cylinder and both sides of the reciprocating piston or means.

1. In a two cycle internal combustion engine having housing means to provide the necessary spaces in the engine, compressor means to force combustible material into the engine, fuel injection means to inject fuel into the engine for combustion, reciprocating means to compress combustible material held within said housing means between the compressor means and the reciprocating means to cause detonation of said combustible material, wherein the improvement comprises the compressor means can compress more combustible material to the combustion process after detonation commences.

2. A two cycle internal combustion engine as defined in claim 1 wherein the reciprocating means includes crankshaft means to cause reciprocating motion of a reciprocating part, receive a power transfer from the reciprocating part during combustion, and output engine torque.

3. A two-cycle internal combustion engine as defined in claim 2 wherein said crankshaft means includes output shaft means to output engine torque.

4. A two-cycle internal combustion engine as defined in claim 3 wherein the compressor means include output shaft means to output and receive engine power.

5. A two cycle internal combustion engine as defined in claim 4 wherein the improvement comprises power transfer means rotatably connecting said crankshaft output shaft means to said compressor output shaft means for a transfer of power between them.

6. A two-cycle internal combustion engine as defined in claim 5 wherein the compressor means is comprised of a positive displacement gear type air compressor to compress combustible material into the engine.

7. A two cycle internal combustion engine as defined in claim 6 wherein said housing means includes cylinder means to confine the movement of the reciprocating means.

8. A two cycle internal combustion engine as defined in claim 7 wherein the reciprocating parts include piston means, piston pin means and connecting rod means with said piston means connected to said piston pin means and the piston pin means rotatably connected to said connecting rod means and the connecting rod means rotatably connected to the crankshaft means for a transfer of power between the crankshaft means and the connecting rod means.

9. A two-cycle internal combustion engine as defined in claim 8 wherein the improvement comprises an exhaust passage means connected between an exterior wall of the housing means and said cylinder means for the release of exhaust gases contained within the cylinder means.

10. A two-cycle internal combustion engine as defined in claim 9 wherein the improvement comprises intake passage means connected between an exterior wall of the housing means and the interior housing space confining the compressor means for passage of combustible material to the compression means.

11. A two-cycle internal combustion engine as defined in claim 10 wherein the improvement comprises passage means connecting the outlet of the compressor means to the cylinder means.

12. A two-cycle internal combustion engine as defined in claim 11 wherein the improvement comprises a fuel injector located within the housing means for injection of fuel into the housing means.

13. A two-cycle internal combustion engine as defined in claim 12 wherein said fuel injector injects fuel between the compressor means and the reciprocating means.

14. A two cycle internal combustion engine as defined in claim 13 wherein the improvement comprises a fuel igniter located within the housing means to ignite combustible material within the housing means between the compressor means and the reciprocating means.

15. A two-cycle internal combustion engine as defined in claim 14 wherein the improvement comprises intake and exhaust valve means to control the flow of fluids moving between engine housing spaces.

16. A two cycle internal combustion engine as defined in claim 15 wherein said valve means includes valve port means formed in the housing means between the compressor means and the cylinder means and a valve to cover said valve port means to control the flow of fluids moving between the compressor means and the cylinder means, and between the cylinder means and the exhaust port means.

17. A two cycle internal combustion engine as defined in claim 16 wherein the improvement comprises oil pump means to pump lubricant to moving parts of the engine

18. A two-cycle internal combustion engine as defined in claim 17 wherein the housing means includes cooling passage means to contain engine coolant and provide a means to remove excess heat from the housing means.

19. A two cycle internal combustion engine as defined in claim 18 wherein the improvement comprises bearing means to provide support to rotating parts.

20. A two cycle internal combustion engine as defined in claim 19 wherein the improvement comprises throttle means to control the supply of gas entering the intake passage means so the combustion process can be controlled.

21. A two cycle internal combustion engine as defined in claim 20 wherein said positive displacement gear type air compressor includes two gear shafts divided into five separate gear pumps to pump all the working fluids the engine uses, air, coolant, oil, and fuel having a air compressor to compress air into the engine, a gear pump to each side of the compressor gears to pump engine oil, and beside one said oil gear pumps a coolant gear pump to pump engine coolant, and beside the other oil gear pump a fuel gear pump to pump engine fuel.

22. A two cycle internal combustion engine having housing means to provide the necessary spaces in the engine, compressor means to force combustible material into the engine, fuel injection means to inject fuel into the engine for combustion, reciprocating means including crankshaft means to compress said combustible material held within said housing means between said reciprocating means and said compressor means to cause detonation of the combustible material so the compressor means can compress more combustible material into the combustion process after detonation commences, wherein the improvement comprises said housing divided into three sections along two parallel planes, one plane intersecting the axes of the gear shafts of the compressor means and the second intersecting the axis of said crankshaft, and said three housing sections held tightly together by fastening means.

23. A two cycle internal combustion engine having housing means to provide the necessary spaces in the engine, compressor means to force combustible material into the engine, fuel injection means to inject fuel into the engine for combustion, reciprocating means to compress combustible material held within said housing between said reciprocating means and said compressor means to cause detonation of said combustible material so the compressor means can compress more combustible material into the combustion process after detonation commences, wherein the improvement comprises valve means to control the movement of fluids within the engine.

24. A two cycle internal combustion engine having housing means to provide the necessary spaces in the engine, compressor means to force combustible material into the engine, fuel injection means to inject fuel into the engine for combustion, reciprocating means to compress combustible material held within said housing between said reciprocating means and said compressor means to cause detonation of said combustible material so the compressor means can compress more combustible material into the combustion process after detonation commences, wherein the improvement comprises ignition means to control when combustion begins.

25. A two cycle internal combustion engine having housing means to provide the necessary spaces in the engine, compressor means to force combustible material into the engine, fuel injection means to inject fuel into the engine for combustion, reciprocating means to compress combustible material held within said housing between said reciprocating means and said compressor means to cause detonation of said combustible material so the compressor means can compress more combustible material into the combustion process after detonation commences, wherein the improvement comprises throttle means to control the flow of combustible material into the engine.

26. A two cycle internal combustion engine having housing means to provide the necessary spaces in the engine, compressor means to force combustible material into the engine, fuel injection means to inject fuel into the engine for combustion, reciprocating means to compress combustible material held within said housing between said reciprocating means and said compressor means to cause detonation of said combustible material so the compressor means can compress more combustible material into the combustion process after detonation commences, wherein the compressor means is comprised of a positive displacement gear type air compressor to compress combustible material into the engine.

27. A two cycle internal combustion engine having housing means to provide the necessary spaces in the engine, compressor means to force combustible material into the engine, fuel injection means to inject fuel into the engine for combustion, reciprocating means to compress combustible material held within said housing between said reciprocating means and said compressor means to cause detonation of said combustible material so the compressor means can compress more combustible material into the combustion process after detonation commences, wherein the improvement comprises power transfer means rotatably connecting the compressor means with the reciprocating means for a transfer of power between them.

28. A two cycle internal combustion engine having housing means including cylinder means to provide the necessary spaces in the engine, reciprocating means to output engine power and force combustion products out of the engine, compressor means to force combustible material into the engine head and compress it there, intake valve means to control fluids passing into the cylinder, wherein the improvement comprises fuel injection means to inject fuel into the engine head upstream of the intake valve to cause combustion to commence within the engine head.

29. A two-cycle internal combustion engine as defined in claim 28 wherein the improvement comprises valve means having valve stems passing between the rotating part of said compressor means.

30. A two cycle internal combustion engine as defined in claim 29 wherein the improvement comprises overhead camshaft means driven by the compressor means.

31. A two-cycle internal combustion engine as defined in claim 30 wherein the improvement comprises intake and exhaust valve means actuated by said overhead camshaft means.

32. A two cycle internal combustion engine as defined in claim 31 wherein the improvement comprises combustion passage means located between the compressor means and the valve means intake valve head.

33. A two-cycle internal combustion engine as defined in claim 32 wherein the improvement comprises fuel injection means to inject fuel into said combustion passage means.

34. A two-cycle internal combustion engine as defined in claim 33 wherein the improvement comprises a camshaft compartment divided along the axis of the camshaft.

35. A two cycle internal combustion engine as defined in claim 34 wherein the improvement comprises spark ignition means located within the engine housing to ignite the fuel mixture compressed within said combustion passage means.

36. A two cycle internal combustion engine as defined in claim 35 wherein the improvement comprises a gear train compartment formed within one end of the engine housing means to contain a camshaft gear drive train rotatably connecting a compressor gear drive gear to a camshaft drive gear.

37. A two-cycle internal combustion engine as defined in claim 36 wherein said camshaft drive gear train includes a crankshaft driven gear fixedly attached to one compressor gear shaft so the crankshaft can drive said compressor gear shaft.

38. A two-cycle internal combustion engine as defined in claim 37 wherein the compressor includes a positive displacement gear type air compressor to compress combustible material into the engine.

39. A two cycle internal combustion engine as defined in claim 38 wherein said positive displacement gear type air compressor is divided into four separate gear pumps, two inner gear pumps to compress combustible material into the engine and two outer gear pumps to pump oil to engine parts requiring lubrication and to reduce the wear of the two main compressor gears.

40. A two cycle internal combustion engine as defined in claim 39 wherein the improvement comprises cooling passages located within the engine head to cool engine head combustion passages, exhaust passages and valves.
